(19) United States
(12) Patent Application Publication
(10) Pub. No.: US 2005/0077647 A1
(43) Pub. Date: Apr. 14, 2005

(54) Method for producing low birefringence plastic film

(76) Inventors: Dennis Joseph Coyle, Clifton Park, NY (US); Kevin P. Capaldo, Mt. Vernon, IN (US)

Correspondence Address: CANTOR COLBURN, LLP, 55 GRIFFIN ROAD SOUTH, BLOOMFIELD, CT, 06002, US

(21) Appl. No.: 10/959,255

(22) Filed: Oct. 6, 2004

Related U.S. Application Data
(63) Continuation-in-part of application No. 10/217,866, filed on Aug. 13, 2002, now abandoned.
(60) Provisional application No. 60/333,565, filed on Nov. 27, 2001.

(51) Int. Cl. B29C 47/88

(52) U.S. Cl. 264/211.12

(57) ABSTRACT

In one embodiment, an extrusion process can comprise: feeding a thermoplastic polycarbonate resin to an extruder; heating the resin in the extruder to a melt temperature that is above a glass transition temperature of the resin, thereby producing a melt of the thermoplastic polycarbonate resin; extruding the melted resin downwardly through an extrusion nozzle orifice having a slot configuration; passing the melted resin downwardly into a gap between two calendering rolls at least one of which has a highly polished surface, and wherein the calendering rolls are maintained at a roll temperature of less than the glass transition temperature; and cooling the thermoplastic polycarbonate resin film to below its glass transition temperature as the thermoplastic polycarbonate resin film advances through the gap.

### CROSS-REFERENCE TO RELATED APPLICATIONS

This application is a continuation-in-part application of and claims priority to U.S. patent application Ser. No. 10/217,866 filed Aug. 13, 2002, which is related to and claims priority from U.S. Provisional Application No. 60/333,565 filed on Nov. 27, 2001.

### BACKGROUND OF THE INVENTION

Disclosed herein is a process for producing thermoplastic film.

Currently polycarbonate is used as the polymeric material for producing articles, such as optical media that are made by injection molding. The process is relatively slow and expensive with one injection molding machine typically producing 1 or 2 discs every 3-5 seconds. While this seems relatively fast, it is actually slow and expensive. In addition, it is difficult to produce discs with the very low birefringence that will be required to reach higher data densities. Typical CD's have a retardation value (birefringence times thickness) of about 25-30 nm (nanometers). Stress and thus birefringence is inherent in injection molding because the melt solidifies on the walls as the mold is filled. Additional material is then forced into the cavity to compensate for shrinkage as the disc solidifies.

Birefringence is defined as the difference between the refractive indices along two perpendicular directions as measured with polarized light along these directions. It results from molecular orientation. The measurement of birefringence is the most common method of characterizing polymer orientation. Birefringence is determined by measurement of the retardation distance by either a compensation or a transmission method. Positive birefringence results when the principal optic axis lies along the chain; negative birefringence results when the principal optic axis lies transverse to the chain. In cartesian coordinates there are three birefringences, two being independent. Thus Δxy=nₓ−n_{y}, the differences in refractive indices along the x and y axes. Uniaxial orientation only requires one of these to describe the orientation. Therefore, in order to obtain a uniform homogeneous polycarbonate, the lower the birefringence (the differences between the refractive indices), the more homogeneous the polymer composition of the product, and thus the more uniform the properties of the product. This is critical, particular in CD's, DVD's wherein the laser read out must have minimal or zero distortion, or in liquid crystal display (LCD) display films where any birefringence of the film will interact with the polarizers to produce undesirable optical effects. The lower birefringence, the less is the variation in polymer homogeneity and laser or other optical distortion.

Improvements in optical data storage media, including increased data storage density, are highly desirable, and achievement of such improvements is expected to improve well established and new computer technology such as read only ROM, write once, rewritable, digital versatile, magneto-optical (MO), and other disks.

In the case of CD-ROM technology, the information to be read is imprinted directly into a moldable, transparent plastic material, such as bisphenol A (BPA) polycarbonate. The information is stored in the form of shallow pits embossed in a polymer surface. The surface is coated with a reflective metallic film, and the digital information, represented by the position and length of the pits, is read optically with a focused low power (5 mW) laser beam. The user can only extract information (digital data) from the disk without changing or adding any data. Thus, it is possible to “read” but not to “write” or “erase” information.

The operating principle is a write once read many (WORM) drive is to use a focused laser beam (20-40 milliwatts (mW)) to make a permanent mark on a thin film on a disk. The information is then read out as a change in the optical properties of the disk, e.g., reflectivity or absorbance. These changes can take various forms such as, “hole burning” which is the removal of material, typically a thin film of tellurium, by evaporation, melting or spalling (sometimes referred to as laser ablation), or bubble, or pit formation involves deformation of the surface, usually of a polymer overcoat of a metal reflector.

Although the CD-ROM and WORM formats have been successfully developed and are well suited for particular applications, the computer industry is focusing on erasable media for optical storage (EODs). There are two types of EODs: phase change (PC) and magneto-optic (MO).

Generally, amorphous materials are used for MO storage and have a distinct advantage in MO storage as they do not suffer from “grain noise”, spurious variations in the plane of polarization of reflected light caused by randomness in the orientation of grains in a polycrystalline film. Bits are written by heating above the Curie point, Tc, and cooling in the presence of a magnetic field, a process known as thermomagnetic writing. In the phase-change material, information is stored in regions that are different phases, typically amorphous and crystalline. The film is initially crystallized by heating it above the crystallization temperature. In most of these materials, the crystallization temperature is close to the glass transition temperature. When the film is heated with a short, high power focused laser pulse, the film can be melted and quenched to the amorphous state. The amorphized spot can represent a digital “1” or a bit of information. The information is read by scanning it with the same laser, set at a lower power, and monitoring the reflectivity.

In the case of WORM and EOD technology, the recording layer is separated from the environment by a transparent, non-interfering shielding layer. Materials selected for such “read through” optical data storage applications must have outstanding physical properties, such as moldability, ductility, a level of robustness compatible with particular use, resistance to deformation when exposed to high heat or high humidity, either alone or in combination. The materials should also interfere minimally with the passage of laser light through the medium when information is being retrieved from or added to the storage device.

As data storage densities are increased in optical data storage media to accommodate newer technologies, such as DVD and higher density data disks for short or long term data archives, the design requirements for the transparent plastic component of the optical data storage devices have become increasingly stringent. Materials displaying lower birefringence at current, and in the future progressively shorter “reading and writing” wavelengths have been the object of intense efforts in the field of optical data storage devices.

Polymeric films are also used to manage light in backlit liquid crystal displays (LCD). The LCD itself consists of pixel elements of liquid crystal material between crossed polarizers. The light from the backlight module is blocked by these polarizers except for the pixel elements that are oriented by the display electronics. The backlight module uses various films to re-direct and/or diffuse the light supplied to the liquid crystal display. Any birefringence in these underlying films will interact with the polarizers and change the intensity and/or color of the display, so these films need controlled birefringence to avoid these unwanted optical effects.

Birefringence in an article molded from polymeric material is related to orientation and deformation of its constituent polymer chains. Birefringence has several sources, including the structure and physical properties of the polymer material, the degree of molecular orientation in the polymer material and thermal stresses in the processed polymer material. For example, the birefringence of a molded optical article is determined, in part, by the molecular structure of its constituent polymer and the processing conditions, such as the forces applied during mold filling and cooling, used in its fabrication, which can create thermal stresses and orientation of the polymer chains.

The observed birefringence of an article is therefore determined by the molecular structure and the processing conditions, which can create thermal stresses and orientation of the polymer chains. The observed birefringence of an article is typically quantified using a quantity termed “in-plane birefringence” or IBR, which is described more fully below.

For a molded article, the IBR is defined as:
IBR=nₓ−n_{y} (1)
And the optical path difference, or retardation, is defined as
Retardation=(nₓ−n_{y})d=Δn d (2)
where nₓ and n_{y} are the refractive indices along the x and y Cartesian axes of the plane of the film (or the radial and azimuthal axes of a disk); nₓ is the index of refraction seen by a light beam polarized along the x direction, and n_{y} is the index of refraction for light polarized along the y direction. The thickness of the disk is given by d. The IBR governs the defocusing margin, and reduction of IBR will lead to the alleviation of problems, which are not correctable mechanically. IBR is a property of the finished optical disk. The optical path length difference between the two axes of polarization is called “retardation” and has units of nanometers. In LCD applications, for example, where the light passes through the thickness of the article, it is the retardation that is the primary quantity of interest and thus the quantity that must be controlled. It is also common to use the terms “birefringence” and “retardation” interchangeably, wherein it is implicitly understood that when doing so the thickness is being considered constant.

In applications requiring higher storage density, such as DVD recordable and rewritable material, the properties of low birefringence and low water absorption in the polymer material from which the optical article is fabricated become even more critical. In order to achieve higher data storage density, low birefringence is necessary so as to minimally interfere with the laser beam as it passes through the optical article, for example a compact disk.

Materials for DVD recordable and rewritable material require low in-plane birefringence, in particular retardations of less than about ±40 nm single pass; excellent replication of the grooved structure, in particular greater than about 90% of stamper.

The great economic advantage of producing optical media at a faster rate via a continuous film extrusion process whereby a continuous plastic film of 4 to 8 feet wide could be produced at speeds of 10-60 feet per minute (ft/min) from which discs or LCD films could be cut out is certainly desired. Extrusion casting, where a melt is extruded through a slot die and deposited on a polished metal roller to solidify, can produce low birefringence film but the top surface of the film is not smooth or uniform enough. Extrusion calendering, whereby a second polished metal roll is added to form a nip or gap to squeeze the plastic on both sides as it solidifies, is widely used to produce very uniform and smooth surface films, but the flow in the nip between rigid rolls induces very high stresses and such films have retardation values of hundreds to thousands of nanometers. A resilient elastomeric cover can be put on one of the rolls to produce textured films that have lower stress, but the texture is unacceptable for most optical media applications.

### SUMMARY OF THE INVENTION

Disclosed herein are processes for making a thermoplastic resin film and the film made therefrom. In one embodiment, the extrusion process can comprise: feeding a thermoplastic polycarbonate resin to an extruder; heating the resin in the extruder to a melt temperature that is above a glass transition temperature of the resin, thereby producing a melt of the thermoplastic polycarbonate resin; extruding the melted resin downwardly through an extrusion nozzle orifice having a slot configuration; passing the melted resin downwardly into a gap between two calendering rolls at least one of which has a highly polished surface, and wherein the calendering rolls are maintained at a roll temperature of less than the glass transition temperature; and cooling the thermoplastic polycarbonate resin film to below its glass transition temperature as the thermoplastic polycarbonate resin film advances through the gap.

In another embodiment, the extrusion process can comprise: extruding melted thermoplastic polycarbonate resin downwardly through an extrusion nozzle orifice, wherein the melted thermoplastic polycarbonate resin has a viscosity of less than or equal to 600 cPs; passing the melted thermoplastic polycarbonate resin through a gap between two calendering rolls, wherein at least one of the calendering rolls has a polished surface, wherein the calendering rolls have a roll temperature of less than or equal to about 140° C.; and cooling the melted thermoplastic polycarbonate resin to below its glass transition temperature to form a polycarbonate film. The polycarbonate film can have a retardation of less than or equal to about 35 nm.

The above described and other features are exemplified by the following figures and detailed description.

### BRIEF DESCRIPTION OF THE DRAWINGS

FIG. 1 is a schematic view of one embodiment of a continuous extrusion system illustrating the extrusion of a thermoplastic melt downward into the nip or gap between two calendering rolls lying in a horizontal plane.

FIG. 2 is a schematic view of another configuration wherein the calendering rolls lie in a plane at an angle of 30° from the horizontal.

### DETAILED DESCRIPTION OF THE INVENTION

It is noted that the terms “first,” “second,” and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt %, with 5 wt % to 20 wt % desired,” are inclusive of the endpoints and all intermediate values of the ranges of “5 wt % to 25 wt %,” etc.). As used herein the term “about”, when used in conjunction with a number in a numerical range, is defined being as within one standard deviation of the number “about” modifies. As used herein, the terms film and sheet are used interchangeable and refer to the thermoplastic material having a final thickness of about 0.005 inches (0.127 millimeters (mm)) to about 0.060 inches (1.52 mm), but may be thicker depending on the final application.

Disclosed herein are a process, a product, and an extrusion system for preparing thermoplastic film, e.g., from polycarbonate resin. The resultant film can have a low birefringence (e.g., a retardation of less than or equal to about 30 nanometers (nm)) and can have a surface having a roughness (Rₐ) of less than or equal to about 4 microinches, or, more specifically, a roughness of about 0.5 to about 2.0 microinches. The transparent thermoplastic film or sheet (hereinafter collectively referred to as “film”) prepared is suitable for optical media applications such as compact discs (CD), digital video disc (DVD), liquid crystal displays (LCD), and any other optical media applications employing a transparent substrate having low birefringence, low stress, and having at least one polished surface with minimal surface roughness. As used herein, unless stated otherwise, the retardation refers to single pass retardation (e.g., with respect to an optical media (such as a DVD), retardation is measured as single pass and double pass (i.e., reflected back)).

The process comprises feeding a polycarbonate resin to an extruder, melting the resin to above its glass transition temperature (T_{g}) while advancing it through the extruder, extruding downwardly the molten resin through the orifice of an extrusion nozzle into the nip or gap between two calendering rolls that are maintained below the T_{g} of the resin, cooling the thermoplastic film to below its glass transition temperature while it passes between the rolls, and optionally storing the cooled film, or further processing the film as desired.

At least one calendering roll can have a highly polished surface so as to provide a thermoplastic film with a surface having a surface roughness of less than or equal to about 4 microinches. However, both calendering rolls may be highly polished to provide both surfaces of the film with a highly polished surface. The polished calendering roll can, for example, be chrome or chromium plated, which are used interchangeably to describe the chromium surface calendering roll. However, other calendering rolls may be employed provided they provide film having a highly polished surface. The second calendering roll can, optionally, be a rubber roll (or a rubber covered roll), such that a matte finish can be attained on one side of the film.

The thermoplastic polycarbonate resin that may be employed in producing the polycarbonate film, includes without limitation, aromatic polycarbonates, copolymers of an aromatic polycarbonate such as polyester carbonate copolymer, blends comprising at least one of the foregoing polycarbonates. For example, the thermoplastic polycarbonate resin can be an aromatic homo-polycarbonate resin such as those polycarbonate resins described in U.S. Pat. No. 4,351,920. The aromatic polycarbonate resin can be obtained, for example, by the reaction of an aromatic dihydroxy compound with a carbonyl chloride. Other polycarbonate resins may be obtained by the reaction of an aromatic dihydroxy compound with a carbonate precursor such as a diaryl carbonate. An exemplary aromatic dihydroxy compound is 2,2-bis(4-hydroxy phenyl) propane (i.e., bisphenol-A (BPA)). A polyester carbonate copolymer can be obtained by the reaction of a dihydroxy phenol, a carbonate precursor and dicarboxylic acid such as terephthalic acid or isophthalic acid or a mixture of terephthalic and isophthalic acid. Optionally, an amount of a glycol may also be used as a reactant.

Depending upon the desired application, the polycarbonate can have a low molecular weight, i.e., a weight average molecular weight of less than 25,000 atomic mass units (amu), or, more specifically, about 13,000 amu to less than 25,000 amu, and more specifically, about 13,000 amu to about 20,000 amu. As stated previously, these polycarbonate resins had previously been regarded as being unsuitable for extrusion. It is further noted that higher molecular weight polycarbonate resin can also be used in this process, e.g., a polycarbonate resin having a weight average molecular weight of 25,000 amu to about 35,000 amu and more.

The resultant film may be transparent or translucent, wherein a transparent film can be smooth on both sides, while a translucent film can be matted on one side of the film. The resultant film has low birefringence (discussed herein with respect to the retardation value), low stress, and is highly polished on at least one surface thereof. The retardation of the resultant film can be less than or equal to about 30 nanometers (nm), or, more specifically, less than or equal to about 20 nm, and more particularly less than or equal to about 15 nm. The surface of the highly polished thermoplastic film can be less than or equal to about 4 microinches in roughness, or, more specifically about 0.5 to about 2.0 microinches in roughness. The film can also have a haze of less than or equal to about 1% as determined by ASTM D 1003-61 using a BYK-Gardner hazemeter.

The process of producing the film can comprise feeding a polycarbonate resin to a screw extruder and heating the resin to above its glass transition temperature (T_{g}) of 300° F. to about 305° F. (about 149° C. to about 152° C.), thereby producing a viscous melt of the polycarbonate resin. The polycarbonate resin can be heated sufficiently above the T_{g} of the resin to attain a desired viscosity. For example, for some polycarbonate (e.g., having a weight average molecular weight of less than 25,000 amu, or, more specifically, having -a weight average molecular weight of less than or equal to about 20,000 amu), the resin can be heated to above the T_{g} to greater than or equal to about 250° C. (or, more specifically, to greater than or equal to about 270° C., or even greater than or equal to about 280° C.), to form a melt. For other polycarbonate (e.g., having a weight average molecular weight of 25,000 amu to about 35,000 amu, or, more specifically, having a weight average molecular weight of about 29,000 amu), the resin can be heated to greater than or equal to about 300° C., or, more specifically, to greater than or equal to 310° C. (e.g., to about 300° C. to about 315° C.), to form a melt. High M_{w} resin(s) can be heated to a sufficient temperature to attain a low viscosity, and low M_{w} resins can be heated to a temperature to attain the same viscosity (although the temperature is lower). The desired viscosity can be less than or equal to about 800 centipoise (cPs), or, more specifically, less than or equal to about 600 cPs, or, even more specifically, less than or equal to about 500 cPs, and yet more specifically, less than or equal to about 400 cPs.

The melt can be extruded downwardly through the orifice of an extrusion nozzle (e.g., a slot), forming a continuous film of molten thermoplastic resin (extrudate). The extrudate can be passed through the nip or gap of a pair of calendering rolls. The calendering rolls are maintained at a temperature below the glass transition temperature (T_{g}) of the resin. If the melt is hot enough such that the viscosity is low enough, then the calendering rolls can be maintained at a temperature sufficiently low to attain the desired retardation (e.g., less than or equal to 30 nm), while sufficiently high to avoid visual polish defects (e.g., chill marks, chatter marks, and the like) in the film. For example, the calendering rolls can be maintained at a temperature of less than or equal to about 140° C., or, more specifically, about 85° C. to about 130° C., or, even more specifically, about 115° C. to about 130° C.

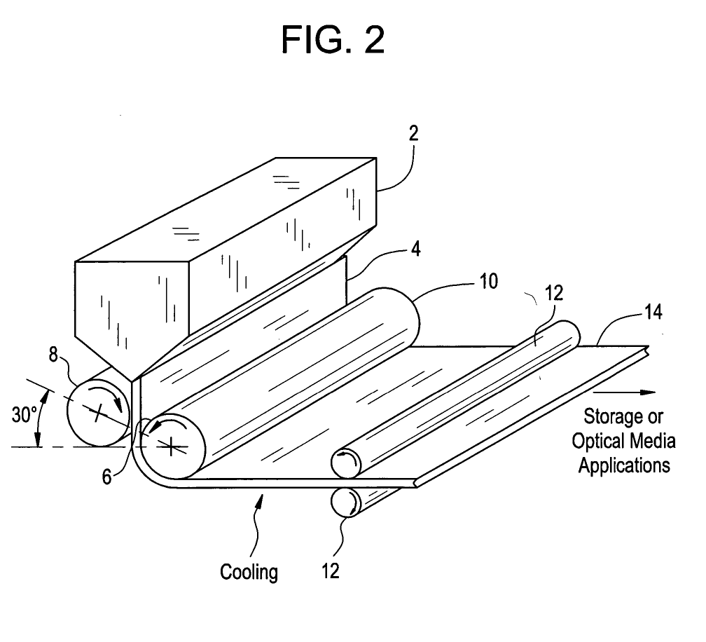

The calendering rolls can essentially lie in a horizontal plane essentially perpendicular to the downward extrusion of the thermoplastic resin to form the finished film, as shown. In another embodiment, the calendering rolls may lie in a horizontal plane or in a plane at any angle of 0° (horizontal; essentially perpendicular to the plane of the downward extruding molten resin) to about 30° from the horizontal. (See FIG. 2) At least partially due to the orientation of the calendering rolls (and therefore the direction of flow of the melted thermoplastic resin), resins having a high or a low weight average molecular weight can be employed in this process. In other words, this process is not limited to “extrusion grade” resins.

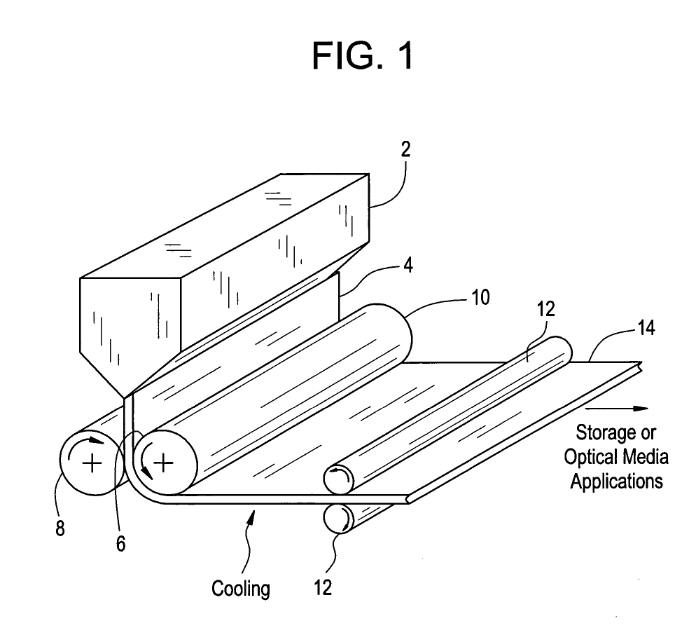

FIG. 1 is a schematic drawing of one embodiment of a continuous process for making a polycarbonate film. FIG. 1 illustrates extrusion nozzle 2 through which polycarbonate resin 4 is extruded. The polycarbonate resin is heated to above the glass transition temperature (T_{g}) of the polycarbonate resin. The extruded melt 4 is passed through nip or gap 6 formed by calendering rolls 8 and 10, is cooled, and then passed through pull rolls 12. The cooled finished film 14, having low birefringence, low stress, and a highly polished surface, can be employed in optical applications such as optical media applications, LCD applications, and so forth.

FIG. 2 is a schematic illustration of another embodiment showing extrusion nozzle 2, nip or gap 6 formed between calendering rolls 8 and 10, cooling film 4, and pull rolls 12. Cooled finished film 14 can be sent to storage or further processed. In this embodiment, rolls 8 and 10 are illustrated as in a plane at an angle of 30° from the horizontal.

The following example is provided merely to show one skilled in the art how to apply the principals of this invention as discussed herein. This example is not intended to limit the scope of the claims appended to this invention.

### EXAMPLES

Polycarbonate films were produced by heating a polycarbonate resin, having a weight average molecular weight as set forth in Table I, to temperatures above its glass transition temperature (T_{g} of about 150° C.) to form a melt. The melt was extruded downward onto horizontally-aligned calendering rolls maintained at a temperature below the glass transition temperature, at a nip force of approximately 50 pounds per inch (lb/in). The melt cooled to below the resin T_{g} as it passed between the rolls. The resultant films had the properties set forth in Table I. The results obtained, melt temperatures, line speed (in meters per minute (m/min)), and molecular weights (weight average) are reported in Table I below. The various thicknesses were 0.010 inches (0.254 millimeters) for Examples 1-9, and 0.024 inches (0.610 millimeters) for Examples 10-15.

Examples 6 and 7 show that, for a 10 mil (0.25 millimeters (mm)) film with all else held constant, increasing the melt temperature of high molecular weight resin from 305° C. to 340° C. drops the retardation from 101 nm to 35 nm. Examples 8 and 9 show that further reduction is possible by lowering the roll temperatures. Examples 1 and 2 show the same melt temperature effect for the low molecular weight resin, while Examples 3-5 show the corresponding roll temperature effect. Examples 10-15 show that low retardation 24 mil thick films can also be made by similar combinations of molecular weight and temperatures. In all cases the viscosity of the melt is much lower than in other extrusion processes.

TABLE 1

| | | Line | | Melt | | Roll 1 | Roll 2 | |
|---|---|---|---|---|---|---|---|---|
| | | Speed | | Temp | Viscosity | Temp | Temp | Retardation |
| Example | M* | (m/min) | M_{w} | (° C.) | (cPs) | (° C.) | (° C.) | (nm) |
| 1 | PL | 16 | 18,000 | 254 | 390 | 122 | 122 | 103 |
| 2 | PL | 16 | 18,000 | 283 | 130 | 122 | 122 | 30 |
| 3 | PR | 15.2 | 18,000 | 274 | 175 | 129 | 135 | 40 |
| 4 | PR | 15.2 | 18,000 | 274 | 175 | 121 | 118 | 32 |
| 5 | PR | 15.2 | 18,000 | 274 | 175 | 116 | 102 | 29 |
| 6 | PL | 16 | 29,000 | 305 | 660 | 122 | 122 | 101 |
| 7 | PL | 16 | 29,000 | 340 | 270 | 122 | 122 | 35 |
| 8 | PR | 13.1 | 29,000 | 322 | 430 | 116 | 121 | 13 |
| 9 | PR | 13.1 | 29,000 | 321 | 430 | 104 | 110 | 12 |
| 10 | PR | 5.6 | 18,000 | 271 | 200 | 107 | 107 | 15 |
| 11 | PR | 5.6 | 18,000 | 271 | 200 | 102 | 102 | 13 |
| 12 | PR | 5.6 | 18,000 | 271 | 200 | 88 | 88 | 14 |
| 13 | PR | 5.5 | 29,000 | 313 | 550 | 127 | 132 | 35 |
| 14 | PR | 5.5 | 29,000 | 313 | 550 | 116 | 121 | 18 |
| 15 | PR | 5.5 | 29,000 | 312 | 550 | 104 | 110 | 15 |

*M—Machine; PR is production and PL is pilot.

Previously, typical extrusion conditions for high molecular weight polycarbonate (e.g., M_{w} of greater than 28,000 amu) include melt temperatures of 275° C. to 285° C. (at which the resin has a viscosity of greater than or equal to 1,000 cPs). This melt is easily extruded in conventional roll-stack configurations, but the resultant films have unacceptable retardation values; typically in the range of 200 nm to 800 nm.

With the present process, films can be produced having a low birefringence, e.g., they can have a retardation of less than or equal to about 35 nm, or, more specifically, less than or equal to about 30 nm, or, even more specifically, less than or equal to about 25 nm, and, yet more specifically, less than or equal to about 20 nm, and even less than or equal to about 15 nm. The examples show that reducing the viscosity of the melt (e.g., by either lowering the molecular weight and/or by increasing the melt temperature) can drastically reduce the retardation. Such low viscosities are only extrudable in the disclosed type of roll stack orientation. The resultant films can be employed, for example, in various optical applications, such as optical media applications (DVD, CD, and the like), and display applications (LCD, and the like), and so forth.

It has been surprisingly discovered that a film can be prepared quickly and economically by downward extruding molten polycarbonate resin into the nip or gap between rolls (e.g., with at least one highly polished roll), particularly polycarbonate. The surprising discovery is that low birefringence film (e.g., polycarbonate film) can be produced by downward extrusion without controls on the film extrudate as it leaves the die orifice. This eliminates the need for controls previously employed to control bead height along the nip of the inlet side of a pair of calendering rolls in order to obtain uniform birefringence across the width of the plastic.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. An extrusion process, comprising:
feeding a thermoplastic polycarbonate resin to an extruder;
heating the resin in the extruder to a melt temperature that is above a glass transition temperature of the resin, thereby producing a melt of the thermoplastic polycarbonate resin;
extruding the melted resin downwardly through an extrusion nozzle orifice having a slot configuration;
passing the melted resin downwardly into a gap between two calendering rolls at least one of which has a highly polished surface, and wherein the calendering rolls are maintained at a roll temperature of less than the glass transition temperature; and
cooling the thermoplastic polycarbonate resin film to below its glass transition temperature as the thermoplastic polycarbonate resin film advances through the gap.

2. The process of claim 1, wherein the thermoplastic polycarbonate resin has a weight average molecular weight of less than 25,000 amu.

3. The process of claim 2, wherein the weight average molecular weight is about 13,000 amu to about 20,000 amu.

4. The process of claim 3, wherein the melt temperature is greater than or equal to about 250° C.

5. The process of claim 4, wherein the melt temperature is greater than or equal to about 270° C.

6. The process of claim 1, wherein the weight average molecular weight is 25,000 amu to about 35,000 amu.

7. The process of claim 6, wherein the melt temperature is greater than or equal to about 300° C.

8. The process of claim 7, wherein the melt temperature is greater than or equal to about 310° C.

9. The process of claim 1, wherein the cooled thermoplastic polycarbonate resin film has a thickness of about 100 μm to about 600 μm.

10. The process of claim 1, wherein the two calendering rolls have highly polished surfaces.

11. The process of claim 1, wherein both surfaces of the cooled thermoplastic polycarbonate resin film have a roughness of less than or equal to about 4 microinches.

12. The process of claim 1, wherein the thermoplastic polycarbonate resin is a bisphenol-A polycarbonate.

13. The process of claim 1, wherein the cooled thermoplastic polycarbonate resin film has a retardation of less than or equal to about 35 nm.

14. The process of claim 13, wherein the retardation is less than or equal to about 25 nm.

15. The process of claim 14, wherein the retardation is less than or equal to about 20 nm.

16. The process of claim 15, wherein the retardation is less than or equal to about 15 nm.

17. The process of claim 1, wherein the melt has a viscosity of less than or equal to about 600 cPs.

18. The process of claim 1, wherein the calendering rolls lie in a horizontal plane to an angle of about 30° from the horizontal plane.

19. The process of claim 1, wherein the roll temperature is less than or equal to about 140° C.

20. The process of claim 19, wherein the roll temperature is about 85° C. to about 130° C.

21. The process of claim 20, wherein the roll temperature is about 115° C. to about 130° C.

22. A polycarbonate film produced in accordance with the process of claim 19.

23. An extrusion process, comprising:
extruding melted thermoplastic polycarbonate resin downwardly through an extrusion nozzle orifice, wherein the melted thermoplastic polycarbonate resin has a viscosity of less than or equal to 600 cPs;
passing the melted thermoplastic polycarbonate resin through a gap between two calendering rolls, wherein at least one of the calendering rolls has a polished surface, wherein the calendering rolls have a roll temperature of less than or equal to about 140° C.; and
cooling the melted thermoplastic polycarbonate resin to below its glass transition temperature to form a polycarbonate film;
wherein the polycarbonate film has a retardation of less than or equal to about 35 nm.

24. The process of claim 23, wherein the polycarbonate film has a haze of less than or equal to about 1%.

25. The process of claim 23, wherein the calendering rolls lie in a horizontal plane to an angle of about 30° from the horizontal plane.

26. The process of claim 23, wherein the thermoplastic polycarbonate resin has a weight average molecular weight of less than 25,000 amu.

27. The process of claim 26, wherein the melt temperature is greater than or equal to about 250° C.

28. The process of claim 23, wherein the weight average molecular weight is 25,000 amu to about 35,000 amu.

29. The process of claim 28, wherein the melt temperature is greater than or equal to about 300° C.

30. The process of claim 23, wherein the viscosity is less than or equal to about 500 cPs.

31. The process of claim 30, wherein the viscosity is less than or equal to about 400 cPs.

32. A polycarbonate film produced in accordance with the process of claim 23.
